(19) United States
(12) Patent Application Publication
(10) Pub. No.: US 2008/0008255 A1
(43) Pub. Date: Jan. 10, 2008

(54) Multiple rate architecture for wireline communication system

(76) Inventors: Raj Kumar Jain, Singapore (SG); Pinxing Lin, Singapore (SG); Hak Keong Sim, Singapore (SG); Chee Kiang Goh, Singapore (SG)

Correspondence Address: BRINKS HOFER GILSON & LIONE, P.O. BOX 10395, CHICAGO, IL, 60610, US

(21) Appl. No.: 11/483,963

(22) Filed: Jul. 10, 2006

(51) Int. Cl. H04K 1/10

(52) U.S. Cl. 375/260

(57) ABSTRACT

A discrete multitone (DMT) transceiver communicates with multiple channels generates and receives DMT symbols each having a duration of a timeslot. A transmitter portion of the transceiver includes a symbol processor which generates symbols for multiple channels sequentially, and stores the generated symbols in a buffer until they are transmitted. A receiver portion simultaneously receives symbols on multiple channels and stores the symbols in a buffer, from which the symbols on different channels are read and processed sequentially. To reduce the rate of communication on a given channel, the symbol processors may be idle in respect of some of the timeslots corresponding to that channel. The transceiver may alternatively be an OFDM transceiver.

### BACKGROUND

1. Technical Field

The disclosure relates generally to communication systems, and particularly to communicating over multiple wireline communication paths.

2. Background Information

Wireline communication standards provide techniques for high-speed data communication over a wire such as a copper telephone wire, referred to as a digital subscriber line (DSL) or transmission using orthogonal frequency division multiplex (OFDM) modulation. Two such standards are asymmetric DSL (ADSL) and VDSL (very-high-data-rate DSL). These permit communication between a central office (CO) and a subscriber device (CPE, “customer premise equipment”) at the other end of the DSL, which may be managed at the central office.

The ADSL and VDSL protocols include transmission over the DSL of discrete multi-tone (DMT) symbols. Each symbol consists of a plurality of tones, and transmitted over time. The symbol rate (i.e. number of symbols transmitted per second) varies, because the symbol includes a cyclic extension of variable length to combat the problem of inter-symbol interference. For example, for the VDSL2 standard, the cyclic extension is defined up to ¼ of a symbol. The granularity is defined by having a cyclic extension given by M/64, where M is an integer in the range 2 to 16. The cyclic extension ratio (rCE) is defined as the ratio of the number of samples of the cyclic extension to the number of samples of the DMT symbols. The cycle extension length (ICE)=N*rCE, where N is the number of samples per symbol excluding the cyclic extension. The rCE can thus take any of the values { 2/64, 3/64, . . . 16/64}.

A portion of the structure of a known VDSL system is shown in FIG. 1. It includes an analogue front-end (AFE) interface 1 which communicates with a wireline via an analogue front end device and a line driver, a physical media dependent (PMD) section 2, and a physical media specific transmission convergence (PMS-TC) section 3. The upper branch of FIG. 1 is the transmission path, and the lower branch is the reception path. In the transmission path, the PMS-TC section 3 performs tasks such as addition of Reed-Solomon checkbytes, interleaving and mapping of VDSL frames into symbols. In the reception path, it performs the inverses of these functions.

The PMD section 2 includes on the transmission path a QT section 21 (which performs QAM and trellis modulation), an intermediate fast-Fourier-transform (IFFT) 22, a peak-to-average reduction (PAR) unit 23, a windowing unit 24, and a high-pass filter 25. Similarly, the reception path includes a high-pass filter 31, a time domain equalization (TDQ) unit 32, a radio-frequency interference (RFI) reduction unit 33, a windowing unit 34, a fast Fourier transform unit 35, a frequency equalization (FEQ) unit 36, an a QAM-Trellis(QT) encoder unit 37. Note that the order of the units may not be exactly as shown in FIG. 1. For example, RFI reduction unit 33 may be after the FFT unit 35, or may alternatively be combined with the RX windowing unit 34 as a single unit. Further the above different processing components could be also implemented by a single or multiple generic or customized processors or DSP's.

Conventionally, a central office (CO) is in communication with multiple subscriber locations using multiple respective DSLs, each of which supports a respective communication channel. In this case, a structure of the kind shown in FIG. 1 is required for each DSL. Note that each of the channels may be transmitting data at a different rate, due to the variable cyclic extension issue described above.

### BRIEF SUMMARY

The present disclosure aims to provide a new and useful methods and apparatus for communicating over a DSL.

In general terms, the present disclosure proposes in a first aspect a DMT or OFDM transmitter which generates DMT symbols. The transmitter includes a symbol processor which generates symbols for multiple channels sequentially, and stores the generated symbols in a buffer unit until they are transmitted.

In a second aspect, the present disclosure proposes a DMT or OFDM receiver which simultaneously receives DMT symbols on multiple channels. The receiver stores the symbols in a buffer unit, and includes a symbol processor which processes the symbols sequentially for multiple channels. The DMT or OFDM receiver and transmitter are typically portions of a single DMT or OFDM transceiver.

Thus, in each of upstream and downstream transmissions, a single symbol processor is required to generate/recognize the symbols for multiple channels. Accordingly, the manufacturing cost of the receiver/transmitter is much reduced, compared to a device which comprises a respective transceiver for each channel. For example, in one embodiment designed by the present inventors for driving four channels, the chip area could be significantly reduced by almost 60%, as compared to a chip area in the case that each of the four channels is provided with its own processor.

Each symbol processor is capable of processing/generating the symbols at a rate which is at least equal to the number of channels multiplied by the maximum symbol generation rate of any of the channels. The time taken by the symbol processor to process/generate a symbol for each of the channels is referred to herein as a “timeslot”. This timeslot is no longer than the reciprocal of the maximum symbol rate, and preferably shorter.

Typically, each symbol processor comprises one or more processing units arranged as a pipeline, in which data generated by one of the processing units is passed to the next. If the number of channels is denoted by C, the symbol processor may partition each of the timeslots (which have a duration denoted by T) into C sub-timeslots (each having a duration of T/C). During each of the sub-timeslots a given one of the processing units operates in respect of a corresponding channel. That is, in a first sub-timeslot a certain processing unit may work in respect of a first of the channels, in the next sub-timeslot it works in respect of a second of the channels, and so on. If during a given sub-timeslot the processing unit is used for processing/generating symbols for a certain one of the channels, then during the sub-timeslot which begins T later it is also used for processing/generating symbols for the same channel.

Note that in some arrangements, more than one of the processing units may be able to operate in respect of the same channel during the same sub-timeslot. For example, in embodiments in which the transmit path includes a QT unit and an IFFT unit, then both may be arranged to be operate quickly enough that, in a given sub-timeslot the QT unit processes data in respect of a given channel and the IFFT unit processes the output of the QT unit. Nevertheless, at any one time preferably at least two processing units of the pipeline are working in respect of different ones of the channels.

Note that in general each of the channels may have a different symbol rate. If any of the channels is in fact required to communicate at a rate which is lower than its maximum rate, then the symbol processor will have idle time in respect of that channel. Conveniently, the symbol processor may by arranged to slow its processing in respect of a given channel by being idle during a complete sub-timeslot in respect of that channel. For example, if the symbol processor is idle during one in ten of the sub-timeslots in respect of a given channel, then its data transmission/reception rate for that channel is multiplied (reduced) by a factor of 0.9. The idle period of the symbol processor is referred to here as an “unused frame”.

Preferably the unused frames are determined dynamically (rather than being predetermined, e.g. by a control device), such as by a measurement by one or more of the processing units of the pipeline of the availability of data to be processed by that processing unit. This may comprises a measurement of the amount of data for a given channel stored in the buffer unit.

In one form, in at least one of the downstream (transmission) and upstream (reception) directions, the buffer unit includes FIFO buffers for each of the channels, and the processing for each channel is controlled based on the pointer values for the corresponding FIFO buffer. For example, on the downstream path, a symbol is not generated when the pointers for the corresponding channel indicate that the corresponding buffer is storing an amount of data which is greater than a predetermined value (e.g. two symbols). Similarly, on the upstream path, a symbol is only processed when the pointers for the corresponding channel indicate that the corresponding buffer is storing an amount of data which is at least a second predetermined value (e.g. one symbol).

### BRIEF DESCRIPTION OF THE DRAWINGS

Preferred features of the disclosure will now be described, for the sake of illustration only, with reference to the following figures in which:

FIG. 1 shows the structure of a known VDSL system.

FIG. 2 shows a system for communicating with multiple wireline systems.

FIG. 3 shows the timing of the downstream units of FIG. 2.

FIG. 4 shows the scheduling of the upstream units of FIG. 2.

### DETAILED DESCRIPTION

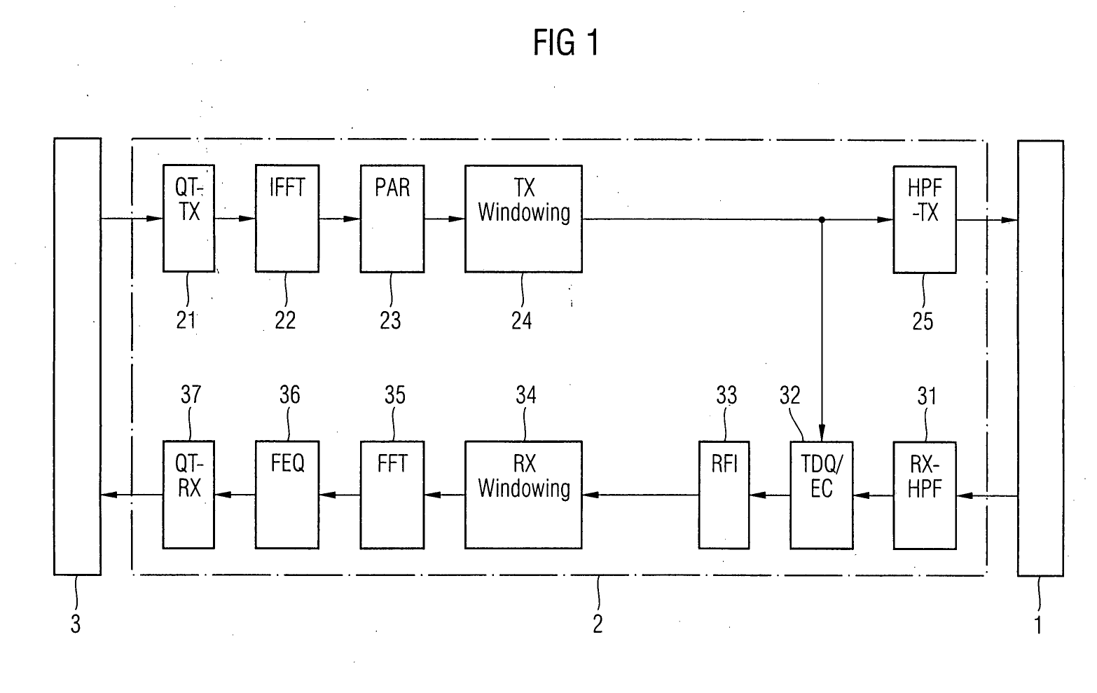

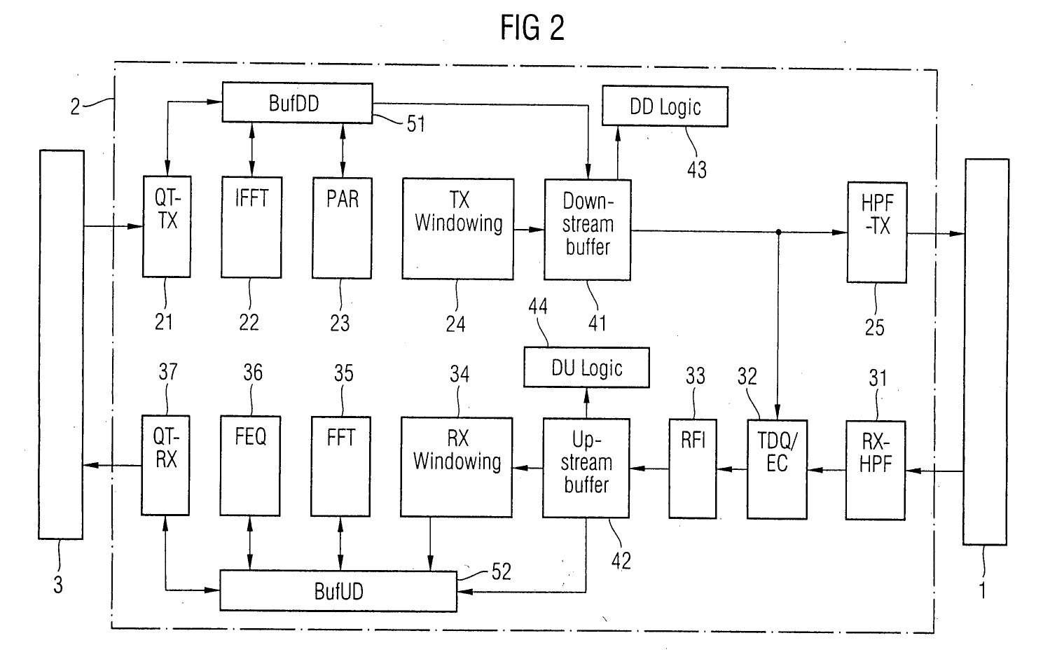

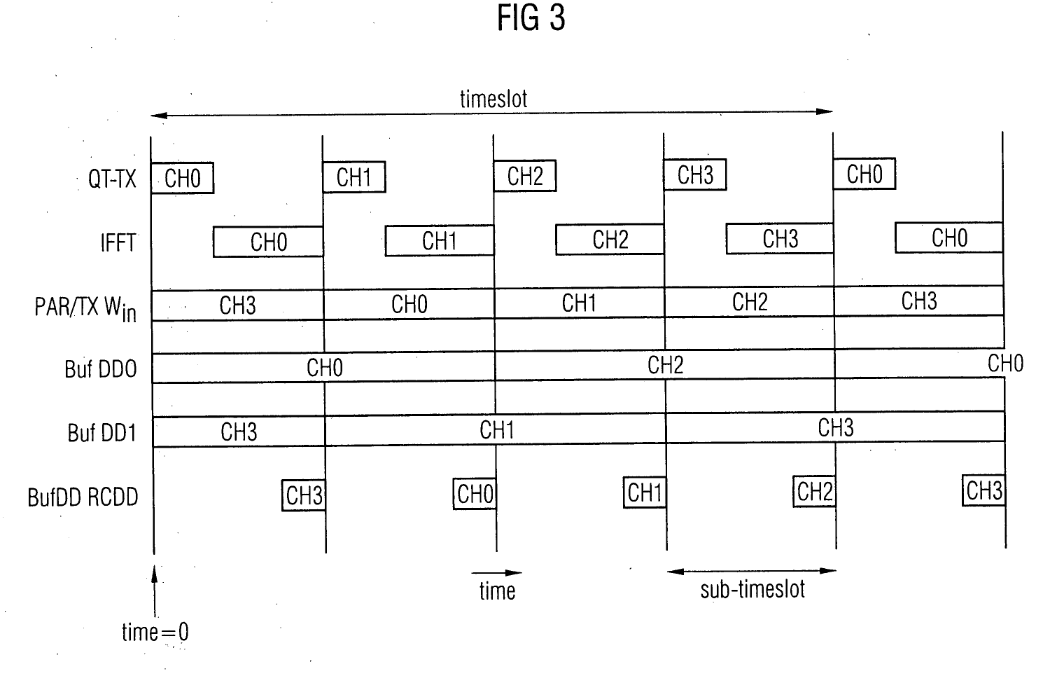

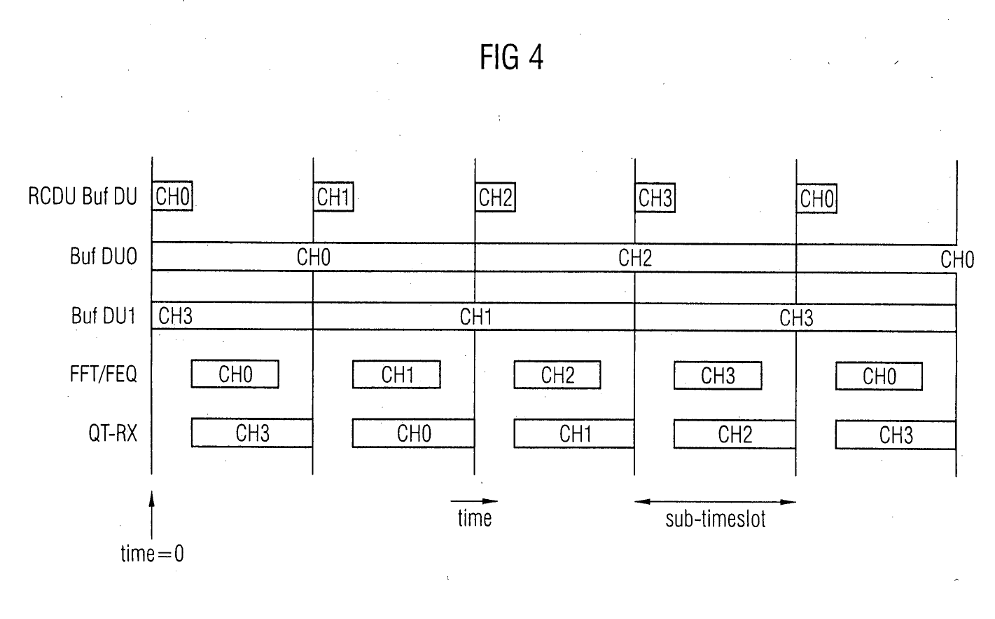

In FIG. 2, a system for communicating with multiple wireline systems is illustrated. Many elements of the embodiment have the same meaning as in FIG. 1, and these are given the same reference numerals. However, the scheduling of the operation of many of the units of FIG. 2 is quite different from that of the embodiment of FIG. 1, as explained below with reference to the FIGS. 3 and 4.

The units 21, 22, 23 and 24 of the downstream path may have access to a shared buffer 51 called BufDD, which is partitioned into two sections BufDD0 and BufDD1. As described in detail below, data passes in a pipeline through the units 21, 22, 23 24 by being written to the BufDD by one of these units, and then being read back from the buffer BufDD by the next unit in the pipeline. Conversely the units 21, 22, 23 and 24 may be operated simultaneously too.

Similarly, the units 42, 34, 35, 36 and 37 have access to a shared buffer 52 called BufDU, which is partitioned into two sections BufDU0 and BufDU1. Data passes along the upstream pipeline by being written to BufDU by one of the units of the pipeline, and then being read back from buffer BufDU by the next unit in the pipeline.

Furthermore, whereas in FIG. 1 each of the upper and lower branches of the embodiment was handling only signals in respect of a single channel, in FIG. 2 each branch handles signals in respect of C channels. We will assume in the following that C=4, however generalizations to other numbers of channels are straightforward to one skilled in this field.

Furthermore, in comparison to the known system, the embodiment includes a downstream buffer unit 41 and an upstream buffer unit 42. As described below, each of these buffer units 41, 42 includes a respective FIFO buffer for each of the channels. In an alternative arrangement, described below, the buffer units 41, 42 instead may include a respective ping-pong buffer for each of the channels.

In the downstream path, the units 21, 22, 23 and 24 of the embodiment each process data in respect of the channels sequentially, thereby acting as a pipeline along which data is passed. The data they generate is stored in the buffer unit 41. The unit 25 simultaneously (or with time multiplexing) reads data from the all four buffers of the buffer unit 41, and after appropriate filtering, interpolation and decimation, passes this data in respect of all four channels to the analogue front-end interface 1. In the downstream path, data in respect of all four channels after being processed by different signal processing modules passes simultaneously (or with time multiplexing) through the units 31, 32, 33, and is written simultaneously into the respective buffers of the buffer unit 42. Data is then read out of the buffer unit 42 channel-by-channel sequentially, and processed sequentially by the units 34, 35, 36, 37.

The embodiment is preferably arranged to be able to operate a number of different communication standards, with different ones of the channels using different ones of the standards. To handle cases including ADSL2(+) without excessively complex rate adaptation, the embodiment is designed to operate at a symbol rate on each channel of 4312.5 Hz (that is a timeslot duration T of about 231.9). Suppose that the maximum symbol rate required of any channel is f1, and that the operating frequency of the hardware modules is given by f2. Then, the number of channels C is such that Cf1/f2 is no greater than the number of cycles required by each of the hardware units 21, 22, 23, 24, 34, 35, 36, 37 to perform its processing in respect of a single symbol. Note that for state of the art designs, the processing of the functional blocks 21, 22, 23, 24, 34, 35, 36, 37 could be distributed over either or single or multiple hardware engines or processor cores. DMT system require symbol based processing whereas the state of art processors or hardware engines are capable of computing a complete IFFT, FFT symbol over a fraction of a complete symbol period.

The scheduling of the downstream path of the embodiment is shown in FIG. 3. The four channels are labeled channels “0”, “1”, “2” and “3”. When one of the processing units 21, 22, 23, 24 is data processing in respect of one of the channels, this is indicated on FIG. 3 by “CH0”, “CH1”, “CH2”, and “CH3” respectively. The left of the diagram corresponds to a time arbitrarily labeled time=0. During the first part of the first sub-timeslot, the QT-TX processor 21 processes data in respect of channel 0, and stores it in BufDD0. During the latter part of this first sub-timeslot, the IFFT unit 22 reads the data from BufDD0, processes the data in respect of channel 0 output by the QT-TX processor 21, and returns the data to BufDD0. The data generated by the IFFT unit 22 in respect of channel 0 is read from the BufDD0 and processed during the next sub-timeslot by the PAR unit 23 and the TX windowing unit 24. The PAR unit 23 passes its output back to the buffer BufDD0. At the end of the second timeslot, the data in the buffer BufDD0 is written to FIFO buffer in the downstream buffer 41 associated with channel 0. This operation is shown on FIG. 3 as “BufDDRCDD”. During the second timeslot, the TX windowing unit 41 reads data from the BufDD0 generated by the PAR unit 23, and transmits it with appropriate timing to the buffer in the buffer unit 41 corresponding to channel 0. Thus, during the second sub-timeslot, the buffer associated with channel 0 in the buffer unit 41 is loaded with all the samples of a complete symbol.

Subsequently, the data generated for channel 0 is transmitted by the unit 25 and the interface 1 over the channel 0. This transmission may for example begin during the third sub-timeslot. However, more typically, the buffer associated with channel 0 is large enough to store more than one symbol, and is arranged to store more than one symbol's worth of samples at any one time. The data generated for channel 0 in the second sub-timeslot of FIG. 3 will only be transmitted once any samples in respect of channel 0 generated in previous timeslots have been transmitted to the respective channel.

Similarly, data in respect of channel 1 is processed by the units 21, 22 during the second sub-timeslot, by the units 23 and 24 during the third timeslot, and transmitted by the unit 25 at some time after the end of the 3rd sub-timeslot.

The scheduling of the other downstream channels follows this principle mutis mutandis. Note that at all times HPF unit 25 is simultaneously (or with time multiplexing) reading data from the downstream buffer 41 and transmitting it over all four channels. FIG. 3 also shows the timing of the buffers BufDD0 and BufDD1. Note that buffer BufDD0 is shared between channels 0 and 2, while buffer BufDD1 is shared between channels 1 and 3.

The scheduling of the upstream path of the embodiment is shown in FIG. 4. The four channels are again labeled channels “0”, “1”, “2” and “3”, and when one of the processing units 34, 35, 36, 37 is data processing in respect of one of the channels, this is indicated on FIG. 3 by “CH0”, “CH1”, “CH2”, and “CH3” respectively. The left of the diagram corresponds to a time arbitrarily labeled time=0. During the first part of the first sub-timeslot, data in respect of channel 0 (which has accumulated in buffer 42 during a timeslot preceding time=0) is read from the buffer 42 into the buffer BufDU0, in an operation marked as “RCDUBufDU”. The operation of the RX-windowing unit for channel 0 is typically just after this transfer operation, and also transfers data into the buffer BufDU0. During a later part of this first sub-timeslot, this data in respect of channel 0 is read from the buffer BufDU0, processed by the FFT unit 35 and written back to the buffer BufDU0. Later still, the data generated by the FFT unit 35 is read from the buffer BufDU0 by the FEQ unit 36, processed, and returned to the buffer BufDU0. This data in respect of channel 0 is processed during the next sub-timeslot by the QT-RX unit 37.

Similarly, data in respect of channel 1, accumulated in the buffer of the buffer unit 42 corresponding to channel 1, is processed by the units 35, 36 during the second sub-timeslot, and by the unit 37 during the third timeslot.

The scheduling of the other upstream channels follows this principle. Note that at all times the units 31, 32, 33 are simultaneously transferring upstream data received over all four channels, and storing it in the upstream buffer 42. We now turn to considering the case in which the channels are not required to transmit at their maximum capacity.

Consider a case in which ND=64 symbols have to be transmitted in NT timeslots. In other words, in a time period of NT timeslots only NE symbols have to be processed. NT=64(1+rCE). To slow down the processing in respect of any given channel, certain units of the DMT processor (units 21, 22, 23, 24 in the upstream direction, and units 34, 35, 36, 37 in the downstream direction) are idle in respect of certain ones of the timeslots corresponding that channel. Assuming a timeslot numbering starting from 0, Table 1 illustrates one suitable allocation of which timeslots are unused during a period of NT in order to produce each of the 15 possible values of rCE. The corresponding values of ICE are given for N values of 4096 and 2048.

TABLE 1

| | ICE | ICE | | |
|---|---|---|---|---|
| rCE | (N = 4096) | (N = 2048) | NT | Unused timeslot numbers |
| 2/64 | 128 | 64 | 66 | — |
| 3/64 | 192 | 94 | 67 | 66 |
| 4/64 | 256 | 128 | 68 | 33, 67 |
| 5/64 | 320 | 160 | 69 | 22, 45, 68 |
| 6/64 | 384 | 192 | 70 | 17, 35, 52, 69 |
| 7/64 | 448 | 224 | 71 | 14, 28, 42, 56, 70 |
| 8/64 | 512 | 256 | 72 | 11, 23, 35, 47, 59, 71 |
| 9/64 | 576 | 288 | 73 | 10, 21, 32, 42, 52, 62, 72 |
| 10/64 | 640 | 320 | 74 | 9, 19, 28, 37, 46, 55, 64, 73 |
| 11/64 | 704 | 352 | 75 | 8, 17, 26, 34, 42, 50, 58, 66, 74 |
| 12/64 | 768 | 384 | 76 | 7, 15, 23, 31, 39, 47, 54, 61, 68, 75 |
| 13/64 | 832 | 416 | 77 | 6, 13, 20, 27, 34, 41, 48, 55, 62, 69, 76 |
| 14/64 | 896 | 448 | 78 | 6, 13, 20, 27, 34, 41, 47, 53, 59, 65, 71, 77 |
| 15/64 | 960 | 480 | 79 | 6, 12, 18, 24, 30, 36, 42, 48, 54, 60, 66, 72, 78 |
| 16/64 | 1024 | 512 | 80 | 5, 11, 17, 23, 29, 35, 41, 47, 53, 59, 64, 69, 74, 79 |

The decision of whether to be idle in respect of a given timeslot may be made dynamically, rather than being controlled based on predefined unused timeslots. This can be done by the downstream and upstream rate converter (RC) logic units 43, 44.

One way in which this can be done, considering firstly the downstream direction, is the case that the buffers in the buffer unit 41 are each circular FIFO buffers. The PAR unit 23 writes a complete symbol into the FIFO in a burst at a fixed time, while samples are extracted from the unit 25 at a constant rate. The writing of the data into the FIFO buffer is done between memory reads. In other words, the memory write and memory read are time multiplexed. Alternatively the memory read and writes could also be sequential. Each FIFO buffer has a write pointer (W) for writing data from the PAR unit 23, and a read pointer (R) used by the HPF unit 25. Based on the values of W and R, the embodiment can determine if the FIFO buffer has enough data to transmit. Let S=66N/64 where N is the symbol size of 4K or 2K, and let L be the size of the buffer, which in the downstream direction is preferably at least 2 times S. Just before a timeslot in which the QT unit 21 is about to start work on a data for a given channel, the RC logic unit 43 determines whether (W−R+L) mod L>2S. If so, then there is still sufficient data in the FIFO to be transmitted in two timeslots, and the RC logic unit 43 sends control signals to ensure that the QT unit 21 does not start processing. Conversely, if (W−R+L) mod L≦2S, then the logic unit 43 controls the QT unit 21 to start operation, and the subsequent modules follow. This mechanism adapts to the different data rate automatically without having to predefine the unused frame timeslots. Note that instead of the RC logic unit 43 controlling the QT unit 21, it may alternatively send control signals to the PMS-TC section 3, ensuring that data is not input into the section 2 in respect of that channel in the given timeslot.

For a timing advance adjustment by an amount TA, the write pointer is adjusted such that the new value is (W−TA+L) mod L. Some unsent data in the FIFO buffer would then be overwritten. TA cannot be more than one symbol, so the corruption is less than one symbol. During the timing advance adjustment there is no need to check if the FIFO buffer has sufficient space. The unused frame timeslot is dynamically adjusted by checking the value of (W−R+L)mod L in the next timeslot.

A similar mechanism can be applied in the upstream direction in the case that the buffer unit 42 includes a FIFO buffer. The RC logic unit 44 only instructs the units 34, 35, 36, 37 to commence operation in the case that the buffer unit 44 stores sufficient data, as determined by the positions of the pointer.

Alternatively, as mentioned above, the buffer units 41, 42 may be implemented with ping-pong buffers instead of FIFO buffers. There may be a ping-pong buffer for each of the channels inside each of the buffer units 41, 42. The ping-pong buffer has two sections. In the downstream direction, at any given time one of the sections is being read to generate data to transmit on the corresponding channel, while the other section of the buffer is available to receive data in respect of the next symbol for that channel. In the upstream direction, at any given time one of the sections is receiving data from the corresponding channel, while the other section of the buffer is available to transmit data to be processed. Once a symbol has been fully transmitted/received, the two buffer sections swap roles.

Suppose, for example, that the buffer unit 42 for the upstream (RX) direction is implemented using ping pong buffers. In this case, when the units 34, 35 are about to start processing data in respect of a given channel, the rate converter logic unit 44 checks that there is sufficient data in the ping pong buffers for that channel. If there is insufficient data, the logic unit 44 sends control signals to ensure that data is not copied into the BufDU 52 and the FFT unit 35 is inhibited. Conversely, if there is sufficient data, data is copied from the filled buffer into BufDU 52 and the FFT unit 35 begins work. Note that at any one time, both buffers are not full. Alternatively the ping-pong buffers could also be implemented as FIFO buffers.

In the ADSL standard, the cyclic extension or cyclic suffix/prefix is not transmitted during an initial training period, and the embodiment is able to cope with the consequent data rate adaptation. When a cyclic extension is present, each symbol is processed in exactly one timeslot, as explained above. However, during the initial training period when the cyclic extension is not enabled, the symbol period is equal to the timeslot. Hence, in the TX (downstream) direction, symbols are processed in a every timeslot. Similarly, in the RX-direction, the rate converter checks per timeslot if there is sufficient data in the ping-pong buffer to perform the FFT processing. When there is sufficient data, the data in the ping-pong buffer is copied into BufDU.

Although only a single embodiment of the invention has been described in detail, many variations are possible within the scope of the disclosure as will be clear to a skilled reader.

For example, the units of the embodiment may be differently arranged from the embodiment of FIG. 2. For example, the RFI unit 33 does not need to be located before the buffer 41 in the upstream pipeline. Instead, it may be after the RX widowing unit 34, after the FFT 35, or incorporated into a single unit which also performs the function of the RX windowing unit or the FFT unit.

Furthermore, whereas in the embodiment described above the system generates/receives data for/from four channels, other embodiments of the invention may service a number of channels which is different from four.

In a further example, although in the embodiment described above the system performs rate adaptation using idle frames (i.e. periodically stopping processing for a channel which has a symbol rate below the maximum), in alternative arrangements the system may be capable of accelerating the processing when necessary. For example, it may be able in a given timeslot to generate/receive selectively either one or two symbols. In each timeslot, it may dynamically determine how many symbols should be generated/received for each of the channels.

Furthermore, while the description above is in terms of a DMT receiver and/or transmitter, it may be adapted to apply to an OFDM receiver and/or transmitter.

It is therefore intended that the foregoing detailed description be regarded as illustrative rather than limiting, and that it be understood that it is the following claims, including all equivalents, that are intended to define the spirit and scope of this invention.

1. A transmitter that generates discrete multitone (DMT) or orthogonal frequency division multiplex (OFDM) symbols for transmission to multiple channels, the transmitter comprising:
a symbol processor operable to generate symbols for the multiple channels sequentially,
a buffer unit operable to store the generated symbols, and
a transmission unit operable to read symbols from the buffer unit and transmit the read symbols simultaneously on corresponding channels.

2. The transmitter of claim 1 wherein the symbol processor comprises a plurality of processing units arranged in a pipeline, wherein each processing unit is operable to process data in different channels sequentially in respective sub-timeslots which are portions of a timeslot, and wherein at least two of the processing units are arranged during each sub-timeslot to process data in different channels.

3. The transmitter of claim 2 wherein the transmission unit is operable to transmit data to each of the channels at an independently variable transmission rate.

4. The transmitter of claim 3 wherein the variable transmission rate in each of the channels is variable by controlling the processing units of the symbol processor to be idle during selected sub-timeslots corresponding to the channel.

5. The transmitter of claim 1 wherein the transmission unit is operable to transmit data to each of the channels in a selected one of a group of protocols comprising at least one ADSL protocol or at least one VDSL protocol.

6. The transmitter of claim 1 wherein the buffer unit comprises a FIFO buffer for each channel, and wherein a timing of the generation of the symbols in each channel is controlled based on the values of pointers for a corresponding FIFO buffer.

7. A receiver that receives discrete multitone (DMT) or orthogonal frequency division multiplex (OFDM) symbols from multiple channels, the receiver comprising:
a receiving unit operable to receive symbols simultaneously from respective channels and store the received symbols in a buffer unit, and
a symbol processor operable to read the symbols from the buffer sequentially, and process the read symbols sequentially.

8. The receiver of claim 7 wherein the symbol processor comprises a plurality of processing units arranged in a pipeline, each processing unit operable to process data in different channels sequentially in respective sub-timeslots which are portions of a timeslot, and wherein at least two of the processing units are arranged during each sub-timeslot to process data in different channels.

9. The receiver of claim 8 wherein the symbol processor is operable to process data received from each of the channels at an independently variable rate.

10. The receiver of claim 9 wherein the processing rate in each of the channels is variable by controlling the processing units of symbol processor to be idle during selected sub-timeslots corresponding to the channel.

11. The receiver of claim 6 wherein the receiver is operable to transmit data to each of the channels in a selected one of a group of protocols comprising at least one ADSL protocol or at least one VDSL protocol.

12. The receiver of claim 7 wherein the buffer unit comprises a FIFO buffer for each channel, wherein a timing of processing of the symbols in each channel is controlled based on values of pointers for a corresponding FIFO buffer.

13. A transmitter that generates discrete multitone (DMT) or orthogonal frequency division multiplex (OFDM) symbols for transmission to multiple channels, the transmitter comprising:
symbol processing means for generating symbols for multiple channels sequentially,
buffer means for storing the generated symbols, and
transmission means for reading symbols from the buffer unit and transmitting the read symbols simultaneously on the corresponding channels.

14. The transmitter of claim 13 wherein the symbol processor means comprises a plurality of processing means arranged in a pipeline, wherein each processing means is operable to process data in different channels sequentially in respective sub-timeslots which are portions of a timeslot, and wherein at least two of the processing means are arranged during each sub-timeslot to process data in different channels.

15. A receiver that receives discrete multitone (DMT) or orthogonal frequency division multiplex (OFDM) symbols from multiple channels, the receiver comprising:
receiving means for receiving symbols simultaneously from respective channels and store the received symbols in a buffer unit, and
symbol processor means for reading the symbols from the buffer sequentially, and process the read symbols sequentially.

16. The receiver of claim 15 wherein the symbol processor means comprises a plurality of processing means arranged in a pipeline, wherein each processing means is operable to process data in different channels sequentially in respective sub-timeslots which are portions of a timeslot, and wherein at least two of the processing means are arranged during each sub-timeslot to process data in different channels.

17. The receiver of claim 15 wherein the symbol processor means is operable to process data received from each of the channels at an independently variable rate.

18. A method for generating DMT or OFDM symbols for transmission to multiple channels, the transmitter comprising:
generating symbols for multiple channels sequentially;
storing the generated symbols; and
reading symbols from the buffer unit and transmitting the read symbols simultaneously on corresponding channels.

19. The method of claim 18 where transmitting the read symbols comprises transmitting data to each of the channels at an independently variable transmission rate.

20. The method of claim 19 wherein transmitting data to each of the channels at an independently variable transmission rate comprises controlling the processing units of the symbol processor to be idle during selected sub-timeslots corresponding to the channel.
